(19) United States
(12) Patent Application Publication
(10) Pub. No.: US 2002/0165748 A1
(43) Pub. Date: Nov. 7, 2002

(54) System and method for organized project development

(76) Inventor: Charles E. Bess, McKinney, TX (US)

Correspondence Address: David G. Wille, Esq., baker Botts L.L.P., Suite 600, 2001 Ross Avenue, Dallas, TX, 75201, US

(21) Appl. No.: 09/847,756

(22) Filed: May 2, 2001

(51) Int. Cl. G06F 17/60

(52) U.S. Cl. 705/8

(57) ABSTRACT

According to one embodiment of the present invention, a method is provided and includes separating a plurality of persons into first and second groups and communicating an issue to each of the groups. The issue relates to a problem to be addressed by the groups. Each of the groups then independently evaluate the issue. The groups then caucus to produce a consensus on an evaluation of the issue. The groups then separate and each group independently generates a proposed strategy. The groups then caucus thereafter, resulting in a consensus on the proposed strategy. The selected proposed strategy is then initiated.

### BACKGROUND OF THE INVENTION

Project management has become increasingly important in today's society. The ability to precisely focus on a task and to delegate persons and resources properly is crucial to effectively address issues facing businesses and organizations in the modern economy. Effective project management is preferred because it generally provides: reduced overall costs in minimizing wasted time and efforts, bolstered morale as a result of a greater overall sense of productivity within a group of employees, and enhanced quality of the final product because of integrated client feedback and cohesion within the group.

One problem associated with current project management techniques is that insufficient attention is given to the organization of participants in the project. Project participants are often lumped together into one group to work on a project. This approach reflects a lack of appreciation for the diversity, i.e. the unique skills and talents, of the individual employee.

Another problem with current project management techniques is that in larger groups of persons, a single person or a small group of persons can dominate project discussions and inhibit other project members from contributing potential responses to the issues presented by the project. This obsequious attitude by nonparticipating members is often a reflection of a single dominant member of the group who possibly holds more authority or expertise than other members of the group. In other cases, a single person who leads project conversations may simply provide an opportunity for other employees to refrain from putting forth a significant effort toward developing a project resolution.

Yet another problem associated with current project management techniques is general frustration resulting from a lack of communication with the client. Many project members become quickly frustrated because they fail to understand the specific goals targeted by the client or how the client wishes the project to be implemented. A lack of communication with the client throughout the course of the project may result in a final product that is not reflective of or inconsistent with the client's expectations.

### SUMMARY OF THE INVENTION

From the foregoing, it may be appreciated that a need has arisen for a system and method for organized project development that avoids some or all of the disadvantages of existing systems that attempt to organize a process associated with executing a project.

According to one embodiment of the present invention, a method is provided to address this need. The method includes separating a plurality of persons into first and second groups and communicating an issue to each of the groups. The issue relates to a problem to be addressed by the groups. Each of the groups then independently evaluate the issue. The groups then caucus to produce a consensus on an evaluation of the issue. Each of the groups then independently generate a proposed strategy for addressing the problem and caucus thereafter resulting in a consensus on the proposed strategy. The selected proposed strategy is then initiated.

Embodiments of the present invention provide a number of technical advantages. One such technical advantage is that according to one embodiment of the invention, client input is given throughout the project development process. By allowing continuous client input, the members of the groups are provided with specific goals and/or specific limitations provided by the client on an ongoing basis. Thus, for example, if finances or timing constraints present issues that are important to the client, these issues may be communicated to the members of the group during various stages associated with the project development process. In this sense, once a final project has been generated using one embodiment of the present invention, the product will reflect the concerns of the client more so than if the client merely communicated his initial issue and was then isolated from the members of the groups for the remainder of the project development process. Thus client expectations are much more likely to coincide with the final product resulting from the process.

Another technical advantage of one embodiment of the present invention is that it takes advantage of the potential diversity associated with the members of the group who will be working on the project. When a single group is divided into a series of sub-groups, each of the sub-groups is forced to formulate a potential response during each of the steps of the project development process. This allows new alternative solutions to be explored and further provides the client with a variety of potential strategies or approaches in attempting to solve the issues that have been presented to the groups.

Yet another advantage of one embodiment of the present invention is that each of the sub-groups may express his or her opinions more freely. When only a single group is actively involved in the project development process, the members of the group having specific expertise or senior authority can often dominate the project development process. Thus, lesser members are discouraged from participating and hence do not contribute potential valuable solutions during the development of the project. The formulation of subgroups allows members of the group to freely express their perspective on the issues presented by the client. The formulation of sub-groups also provides an opportunity for creative potential alternatives to be explored that otherwise would go unidentified.

Some, all, or none of the above-described advantages may be realized by embodiments of the invention. Other technical advantages are readily apparent to one skilled in the art from the following figures, descriptions, and claims.

### BRIEF DESCRIPTION OF THE DRAWINGS

A better understanding of the present invention will be realized from the detailed description which follows, taking in conjunction with the accompanying drawings in which:

FIG. 1 is a block diagram illustrating a development process for organized project development in accordance with one embodiment of the present invention;

FIG. 2 is a block diagram illustrating additional details relating to a series of steps associated with the development process of FIG. 1; and

FIG. 3 is a flow chart showing a series of steps associated with the operation of the development process of FIG. 1.

### DETAILED DESCRIPTION OF EXAMPLE EMBODIMENTS OF THE INVENTION

Example embodiments of the present invention and their advantages are best understood by referring now to FIGS. 1 through 3 of the drawings in which like numerals refer to like parts.

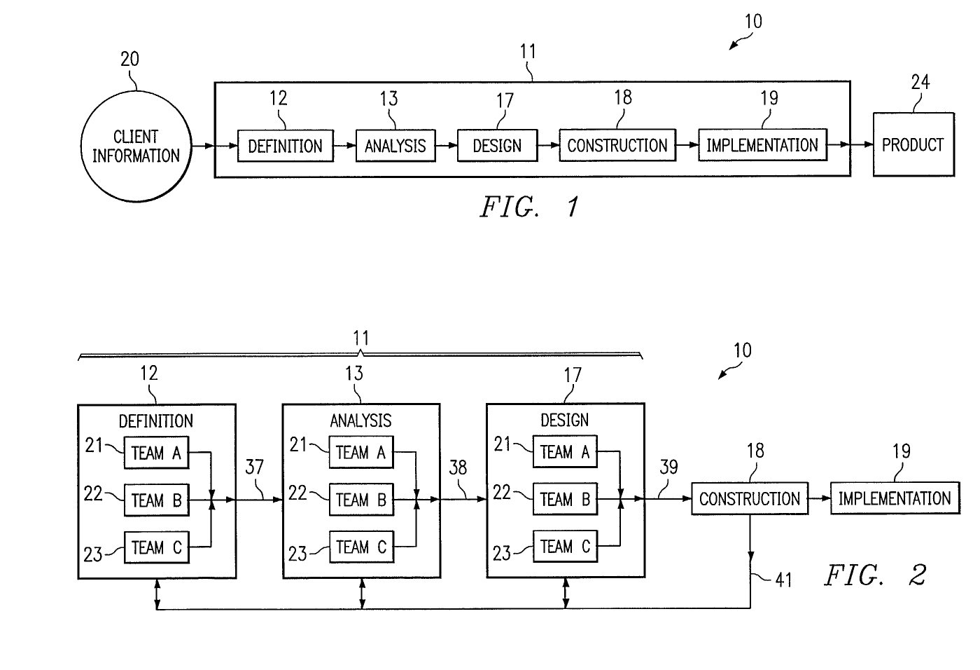

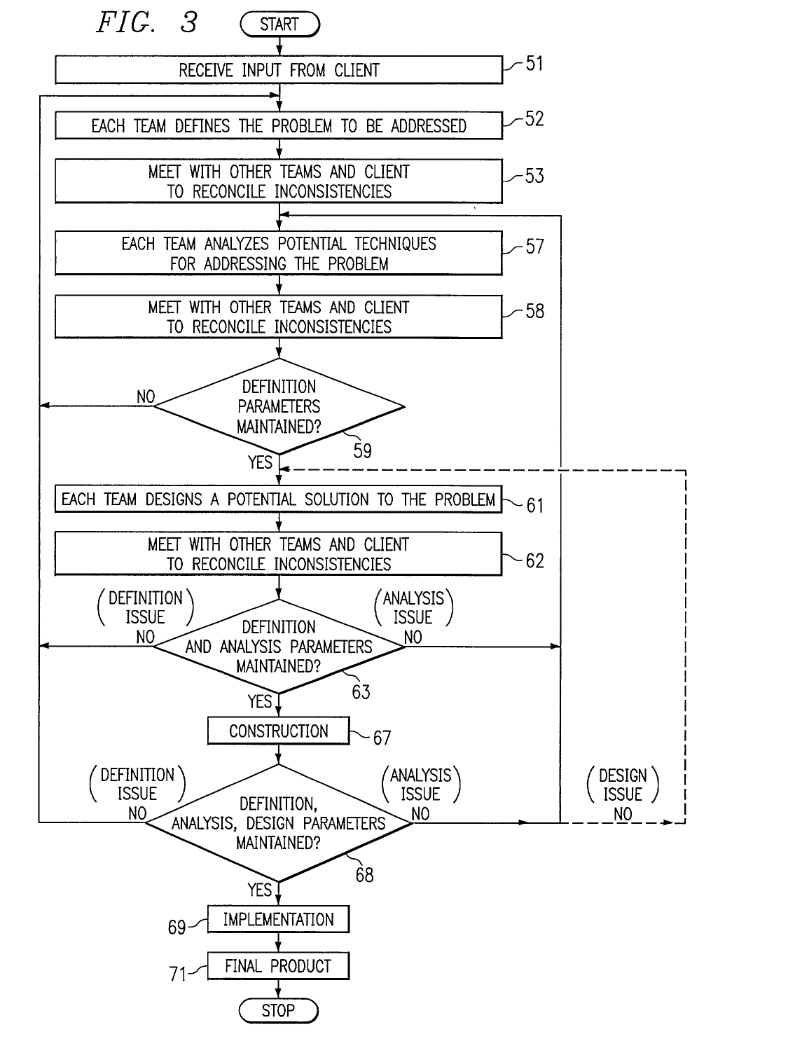

FIG. 1 is a block diagram illustrating the overall organization of a project development process 10 in accordance with one embodiment of the present invention. Process 10 includes a series of steps 11 associated with accomplishing a business task and include: a definition step 12, an analysis step 13, a design step 17, a construction step 18, and an implementation step 19. Steps 11 represent a series of steps to be performed in order to solve an issue presented by a client, customer, or individual for example. FIG. 1 illustrates a general overview of steps 11, with additional details relating to steps 11 subsequently provided with reference to FIG. 2.

At definition step 12, a body of client information 20 is provided, which may correlate to a set of requirements relating to the problem to be addressed using development process 10. A problem such as software generation and design, for example, could be resolved using process 10. For purposes of explanation, a specific example of a software-related problem to be solved by development process 10 is provided later in conjunction with FIG. 3. At definition step 12, client information 20 is communicated to a set of groups of persons (the groups being selected and separated prior to initiation of definition step 12) that will be involved in resolving the problem using development process 10. The groups utilize client information 20 to evaluate generally why the project should exist. In addition, the groups may evaluate the value associated with performing the activity being addressed by the project. The groups may also use client feedback to ascertain the specific goals expressed by the client, customer, or individual presented with the problem or issue. At definition step 12, the client may also communicate any relevant parameters such as: data relating to financial budgetary constraints, timeframes associated with each step of the project, or information that may otherwise impact the project, for example.

Analysis step 13 represents a stage in which each of the groups further evaluate potential techniques that are available to solve the problem presented by the client. The techniques addressed at analysis step 13 are those techniques that generally represent a potential match with some issue related to the problem to be addressed using development process 10. Thus, for example, an issue associated with wireless telecommunications would generally not warrant the consideration of techniques in analysis step 13 that correlate to e-commerce solutions.

Design step 17 represents a stage in which proposed strategies or responses are generated. The techniques formulated in analysis step 13 are further developed to include additional details of potential solutions or proposed strategies associated with the problem presented by the client. During design step 17, members of the group begin contemplating how a potential technique will be applied to the problem in order to make an offered solution production ready. For example, a prototype may be generated by members of the group at design step 17. Generally the issue to be addressed in design step 17 relates to the execution or operation of the proposed strategy.

Construction step 18 represents a stage in which components, applications, or other elements associated with completion of the project are generated or developed. Construction step 18 may involve more persons being added to development process 10 for purposes of effecting the production of the potential solution relating to the problem presented by the client. Construction step 18 is a result of the analysis and evaluations performed in prior steps of process 10 and essentially initiates the composition of materials that will be reflected in a final product 24 generated by process 10.

Finally, at implementation step 19, the elements created in construction step 18 are actually put into place, i.e. incorporated into final product 24 to be presented to the client. Components, applications, and other related elements generated in construction step 18 are installed, injected or otherwise included in the potential solution to the problem addressed by development process 10. Additional items to be installed at implementation step 18 may include: backup components, security measures, and fail-over elements, for example.

According to the teachings of the present invention, definition step 12, analysis step 13, and design step 17 may each include a caucusing or conferencing step in which inconsistencies may be reconciled and conflicts resolved such that a consensus is reached before moving to the following step. This allows the groups to minimize wasted time and effort by forcing both groups to be highly concentrated and focused on the best potential resolution (at each step) to the problem being addressed. This organizational structure also facilitates enhanced independent thinking within each group because the groups are required to formulate their respective conclusions while isolated from each other. Development process 10 also provides a potential feedback loop (to be discussed in more detail with reference to FIG. 2) that allows the groups to receive external information (such as client input, for example) that may redirect their efforts or temper their evaluation and analysis with these concerns. This feedback element may also dictate that the groups return to some early step in process 10 in order to refine or reevaluate a particular step before moving to a following step.

Turning now to FIG. 2, FIG. 2 is a block diagram illustrating additional details relating to definition step 12, analysis step 13, design step 17, construction step 18, and implementation step 19 within development process 10. In the example embodiment illustrated in FIG. 2, a group of people are divided into three teams: Team A 21, Team B 22, and Team C 23. Although the group of people used in development process 10 have been divided into three teams, any number of groups, including any number of members, may be formed in order to carry out steps 11 of development process 10. This division of a group of persons into teams stands in contrast to previous techniques in which no such separation among persons is used; such systems are often collectively referred to as a “waterfall process.”

A “waterfall process” of organizing a project is used to similarly execute a business task with a group of persons. The waterfall methodology involves gathering all persons involved in a project into a single group and focuses all members of the group on a single task. Initially a set of client requirements are given to everyone in the group. At a definition step, the group as a collective whole attempts to define an issue presented by the client. The waterfall development process then moves to an analysis step where again the group collectively analyzes the issue presented by the client. At a design or evaluation step, the group collectively generates a solution. At a construction step, all members of the group participate in creating components necessary for the potential resolution to be initiated. Finally at an implementation step, the elements constructed at construction step are presumably put into place.

This traditional methodology relating to a project development process is generally inadequate for a number of reasons. One reason this methodology is flawed is that it does not provide a mechanism for continuous client feedback. In traditional project development processes, such as the “waterfall process,” the client is only involved in the process when communicating client requirements to the group of persons nominated to resolve the issue presented. In addition, such a traditional “waterfall process” inhibits other members of the group from exploring alternative potential solutions after a member of the group has asserted a solution based on some previous experience or some prior similar issue to which he was involved.

Turning back now to FIG. 2, FIG. 2 illustrates that Team A 21, Team B 22, and Team C 23 are isolated from each other as they work on each of the steps associated with development process 10. In addition, FIG. 2 illustrates that each of the teams caucus at a common point during several of the early steps of development process 10, before proceeding to the next step in the process. Thus, for example, once a client has communicated client requirements to Team A 21, Team B 22, and Team C 23, each team independently executes definition step 12 of development process 10. Once each of the teams has reached a set of agreed upon parameters, the teams meet at a conferencing step 37 to resolve any inconsistencies related with the ideas that were formulated by each of the individual teams. At conferencing step 37, the teams will also delete any redundant ideas formulated by the teams. Once a consensus has been reached from definition step 12 at conferencing step 37, the teams are separated again and then move to analysis step 13. Team A 21, Team B 22, and Team C 23 may be regrouped or reorganized at any time during steps 11 of development process 10. In addition, portions of ideas, concepts or other related matters from each respective team may be used to generate a single amalgamated resolution or expression at any of steps 11 of development process 10.

At analysis step 13, each of the teams evaluate potential techniques that may be implemented to solve the issue presented by the client. Each of the teams formulate potential responses independent of the other teams. Once each of the teams have completed analysis step 13, the teams again meet at a conferencing step 38 to resolve any inconsistencies in the ideas, concepts, or expressions generated by the teams. In addition, at conferencing step 38 redundancies are deleted and conflicts are reconciled in order to reach a consensus from analysis step 13. The consensus is generally reached before moving on to design step 17. Once a consensus has been reached, the teams are separated again and each of the teams enter design step 17.

At design step 17, each of the teams independently generate proposed strategies, formulating additional details relating to the potential solutions developed in analysis step 13. Design step 17 essentially answers the question relating to how a potential solution will be production-ready. At design step 17, this may include, for example, developing a prototype to be used to address the problem presented by the client. Once each of the teams has attempted to formulate additional details relating to potential solutions that address the problem presented by the client, the teams meet again at a conferencing step 39. In a conferencing step 39, the teams communicate with each other to resolve inconsistencies, delete redundancies, and reconcile any conflicts between the teams regarding issues relating to the problem presented by the client to be solved by development process 10. Once a consensus associated with design step 17 has been reached, a construction step 18 is then initiated. At construction step 18, additional members may be added to the project to begin construction of the potential solution that addresses the issue presented by the client. This construction may involve writing applications, making components, and generating specifications, for example, all of which relate to the actual creation of the proposed strategy addressing the issue presented by the client.

At conferencing steps 37, 38 and 39 the client, who presented the issue to be addressed by development process 10, is free to participate in resolving inconsistencies or deleting redundancies. In addition, the client may provide any other considerations or suggestions that may effect the outcome of product 24 generated by development process 10. This client involvement is helpful in ensuring that the desired end-product reflects the remedy anticipated by the client. In sharp contrast to the previous methodologies as described above, development process 10 allows the decisions made at each of conferencing steps 37, 38, and 39 to be tempered with the client's perceptions or concerns associated with the potential resolutions. Thus, for example, this would avoid the problem of proceeding through the steps of development for a given project and arriving at a construction step that contemplates a solution that is simply not affordable to the client. When this occurs considerable time, expense, and effort is wasted because now the group must return to an earlier step of the project in redefining and reanalyzing other potential solutions that are more economically feasible.

FIG. 2 also illustrates a feedback loop 41 that reflects this client involvement concept. Feedback loop 41 allows each of the steps to be reevaluated at any time during the process associated with development process 10. This reevaluation may assist in guiding the teams to a precise resolution of the client's problem. Thus, for example, if a client provided an issue relating to his business of operating an e-commerce site and the problem was defined at definition step 12 as having a certain number of users of the site; and if at design step 17 it is learned that there will be significantly more users of the site than previously anticipated, Team A 21, Team B 22, and Team C 23 may return to a prior step in order to redefine the problem to reflect the change. Thus, as illustrated in FIG. 2, feedback loop 41 allows the teams to return to any prior step in development process 10 before proceeding to a further step.

At implementation step 19, the objects constructed at construction step 18 are effectively put into place. In addition, at implementation step 19, staff members may be put into place, components may be installed into a potential process that addresses the problem presented by the client, and back-up or fail-over elements may be secured to ensure efficient operation of the potential solution produced by development process 10.

FIG. 3 is a flow chart showing a series of steps associated with the operation of development process 10 of FIG. 1 according to one embodiment of the present invention. A description is provided here that details one example use of process 10 with reference to software development. Software development has been provided for exemplary purposes only; the present invention contemplates that any business task involving a group of persons may be accomplished in conjunction with development process 10.

At a first step 51, input is received from the client relating to client requirements such as financial constraints and timing concerns associated with the software development. This information is received by the teams involved in formulating a response to the software development issue presented by a client. At a second step 52, each of the teams independently define the problem presented by the client to be addressed by development process 10. Thus for example, if a client wanted to initiate software relating to a website for selling goods or services on-line at step 52, each of the teams would independently discern associated parameters. One such parameter could be fees charged by an internet service provider (ISP), another such parameter could be a specific demand for the client's website in a particular geographic area. At a third step 53, each of the teams (and potentially the client) meet with each other to reconcile any inconsistencies or conflicts presented by the definitions formulated in the previous step. Thus, for example, one team may have realized that there are potential international considerations which need to be addressed before proceeding to the next step. A consensus on this sub-issue would need to be resolved before proceeding further. Portions of each of the ideas suggested by the teams may be used to generate a single definition for the problems sought to be addressed by development process 10 before proceeding to the next step. In the alternative, an idea offered by one team may simply be selected, in its entirety, over other ideas provided by the other teams. Once a consensus has been reached and all differences reconciled, the teams are separated again and move to the next step in process 10.

At a fourth step 57, each of the teams evaluate potential techniques that are available to address the problem presented by the client. These techniques are generally relevant to the issue being addressed. For example, Internet-related solutions may be highly relevant to the example issue provided herein, whereas wireless communication solutions might not be relevant. At a fifth step 58, the teams may again meet with each other and the client to reconcile any inconsistencies, redundancies or conflicts associated with the information generated at step 57. Once a consensus has been reached at step 58, the teams then conference to at a decisional step 59 and consider whether all parameters relating to the definition process addressed at step 52 have been maintained. If definition parameters have been changed or modified in anyway, the groups may return to step 52 in order to redefine a problem to be addressed by development process 10. An example of a changing parameter in the provided example that may require returning to step 52 might be an increase of users of the client's e-commerce site by 70% during the lunch hour. If the site is not capable of handling this capacity, this issue would need to be addressed before moving forward. Provided the parameters remain constant, the teams are separated again and each of the teams move to a seventh step 61 as illustrated in FIG. 3.

At step 61, each of the teams independently formulate potential prototypes or solutions based on the analysis performed at step 57. Once these potential solutions are reached at step 61, the teams meet with each other and the client, at an eighth step 62, to again reconcile inconsistencies or differences in the information generated. Once a consensus is reached, the teams may then move to a decision step 63, similar to decision step 59, in which parameters relating to step 52 and step 57 are reviewed for inconsistencies. If changes, modifications, or conditions have arisen that relate to step 52, the teams may return to step 52 to redefine the problem to be addressed by development process 10. In addition, if any modifications or new matter has become available relating to step 57, the teams return to step 57 to reevaluate potential techniques for addressing the problems presented by the client. If the parameters remain unchanged, the teams may then move to a tenth step 67.

At step 67, the elements and components needed to implement the prototype or potential solutions developed in steps 61, 57 and 52 are constructed. At step 67, in the provided example, applications may be written, components may be manufactured, or other objects may be created that facilitate implementation of the final product software generated by development process 10. Once these objects have been constructed, a final decision step 68 is reached in which all parameters relating to the previous steps associated with development process 10 are reviewed for conformity and general consistency with client input and any other additional matters, factors, or concerns that have become known to the teams.

If any of the parameters associated with previous steps have been modified, changed or altered, the teams may at this point return to any of the previous steps in order to reorganize or readdress any aspect of the process. If the parameters have been maintained, the teams may then move to a twelfth step 69. At step 69 the objects constructed at step 67 are implemented. Implementation relating to the provided software example may include tasks such as: installing components in a process, setting up back-up or fail-over objects to ensure efficient operation of the process, and positioning staff in appropriate places. At a thirteenth step 71, a final product is yielded as a result of step 69. Any final details or fine-tuning of the implemented process is addressed at step 71. The final product may reflect continuous client input throughout virtually every step in development process 10. The final product should essentially be suitable for client inspection. If client input has been provided, the final software product generated by development process 10 should be consistent with client expectations.

Although several embodiments have been illustrated and described in detail, it will be understood that various substitutions and alterations can be made therein without departing from the present invention. For example, although development process 10 has been described with reference to a business environment, development process 10 could be implemented into any setting, environment, scenario or instance that requires a group of persons to address an issue to be resolved. In addition, although development process 10 has been described with reference to a group of persons being divided into further groups and addressing an issue presented by a client, the group may be divided into individual members representing an entire team while still realizing the present invention. Other substitutions and alterations are also possible without departing from the spirit and scope of the present invention, as described by the following claims.

What is claimed is:

1. A process comprising:
separating a plurality of persons into first and second groups;
communicating an issue to each of the groups, wherein the issue relates to a problem to be addressed by the groups;
evaluating, by each group independently of the other group, the issue that is communicated to the groups;
caucusing, by the groups, such that a consensus on an evaluation of the issue is reached;
generating, by each group independently of the other group, a proposed strategy for addressing the problem;
caucusing, by the groups such that a consensus is reached on the proposed strategy; and
initiating the selected proposed strategy that represents a consensus among the groups.

2. The method of claim 1, wherein the communicating step is performed by a client, and wherein the client also communicates requirement information relating to the issue to the groups, the requirement information defining parameters associated with the issue.

3. The method of claim 2, wherein the selected one of the strategies corresponds to a plan operable to guide an execution thereof, and wherein portions of ideas contributed by each of the groups are selectively incorporated into the plan.

4. The method of claim 3, further comprising providing a feedback loop operable to re-direct the groups to a previous one of the steps in response to one of a new condition and a modified parameter, wherein the new condition and the modified parameter are associated with the issue.

5. The method of claim 4, further comprising reorganizing the persons into third and fourth groups, wherein the third and fourth group are different from the first and second groups, and wherein the re-organizing step is operable to be implemented at any one of the steps.

6. The method of claim 5, wherein the issue is a task in a business environment that is associated with computer software, and wherein the selected one of the strategies is a response associated with accomplishing the task.

7. The method of claim 6, wherein the plan is a written document.

8. The method of claim 6, wherein the plan is in a computer readable form.

9. The method of claim 6, wherein the plan is modified in response to input from the client.

10. The method of claim 6, wherein the plan includes graphical illustrations that facilitate an understanding of the plan.

11. The method of claim 6, further comprising constructing and implementing the plan, wherein the constructing step includes development of applications associated with the plan, and wherein the implementing step includes installation of elements that facilitate execution of the plan.

12. An article of manufacture prepared by a process comprising:
separating a plurality of persons into first and second groups;
communicating an issue to each of the groups, wherein the issue relates to a problem to be addressed by the groups;
evaluating, by each group independently of the other group, the issue that is communicated to the groups;
caucusing, by the groups, such that a consensus on an evaluation of the issue is reached;
generating, by each group independently of the other group, a proposed strategy for addressing the problem;
caucusing, by the groups such that a consensus is reached on the proposed strategy; and
initiating the selected proposed strategy that represents a consensus among the groups, the selected proposed strategy being reflected in the article of manufacture.

13. The article of manufacture prepared by the process of claim 12, wherein the communicating step is performed by a client, and wherein the client also communicates requirement information relating to the issue to the groups, the requirement information defining parameters associated with the issue.

14. The article of manufacture of claim 12, wherein the selected one of the strategies corresponds to a plan operable to guide an execution thereof, and wherein portions of ideas contributed by each of the groups are selectively incorporated into the plan.

15. The article of manufacture of claim 13, wherein the issue is a task in a business environment associated with computer software, and wherein the selected one of the strategies is a response associated with accomplishing the task.

16. The article of manufacture of claim 14, wherein the plan is a written document.

17. The article of manufacture of claim 14, wherein the plan is in a computer readable form.

18. The article of manufacture of claim 14, further comprising providing a feedback loop operable to redirect the groups to a previous one of the steps in response to one of a new condition and a modified parameter, wherein the new condition and the modified parameter are associated with the issue.

19. A method for performing a business task comprising:
identifying a plurality of subtasks, each having an associated result;
assigning a plurality of groups of persons to at least one of the subtasks in order to generate the associated result;
generating, by each group independently of the other, a proposed strategy for addressing the business task;
caucusing, by the groups, resulting in a consensus on the proposed strategy; and
initiating the selected proposed strategy that represents a consensus among the groups, the selected proposed strategy being associated with completion of the business task.

20. The method of claim 19, wherein the subtasks are selected from the group consisting of:
a definition step, an analysis step, and a design step, wherein an issue associated with the result is defined at the definition step, the issue being evaluated at the analysis step with a set of proposed strategies relating to the issue being generated at the design step.

21. The method of claim 20, wherein each step comprises at least two groups of persons engaged in the associated step.

22. The method of claim 21, further comprising providing a feedback loop operable to re-direct the groups to a previous one of the steps in response to one of a new condition and a modified parameter, wherein the new condition and the modified parameter are associated with the issue.

23. The method of claim 22, wherein the selected one of the strategies corresponds to a plan operable to guide an execution thereof, and wherein portions of ideas contributed by each of the groups are selectively incorporated into the plan.

24. The method of claim 22, wherein the issue is a task in a business environment that is associated with computer software, and wherein the selected one of the strategies is a response associated with accomplishing the task.

25. The method of claim 22, wherein the plan is a written document.

26. The method of claim 22, further comprising constructing and implementing the plan, wherein the constructing step includes development of applications associated with the plan, and wherein the implementing step includes installation of elements that facilitate execution of the plan.

27. A method of generating computer software, comprising;
accessing requirement information associated with software development from a client;
separating a plurality of persons into first and second groups;
communicating a software-related issue to each of the groups, wherein the issue relates to a software problem to be addressed by the groups;
evaluating, by each group independently of the other, the issue that is communicated to the groups;
caucusing, by the groups such that a consensus on an evaluation of the issue is reached;
generating, by each group independently of the other, a proposed strategy for addressing the software problem;
caucusing, by the groups, such that a consensus on the proposed strategy is reached; and
initiating the selected proposed strategy that represents a consensus among the groups.

28. The method of claim 27, wherein the communicating step is performed by a client, and wherein the client also communicates requirement information relating to the issue to the groups, the requirement information defining parameters associated with the issue.

29. The method of claim 28, wherein the selected one of the strategies corresponds to a plan operable to guide an execution thereof, and wherein portions of ideas contributed by each of the groups are selectively incorporated into the plan.

30. The method of claim 29, further comprising providing a feedback loop operable to re-direct the groups to a previous one of the steps in response to one of a new condition and a modified parameter, wherein the new condition and the modified parameter are associated with the issue.

31. The method of claim 30, further comprising the step of re-organizing the persons into third and fourth groups, wherein the third and fourth group are different from the first and second groups, and wherein the reorganizing step is operable to be implemented at any one of the steps.

32. The method of claim 31, wherein the plan is a written document.

33. The method of claim 31, wherein the plan may be modified in response to input from the client.

34. The method of claim 31, further comprising constructing and implementing the plan, wherein the constructing step includes development of applications associated with the plan, and wherein the implementing step includes installation of elements that facilitate execution of the plan.
